(19) United States
(12) Patent Application Publication
(10) Pub. No.: US 2026/0247279 A1
(43) Pub. Date: Aug. 20, 2026

(54) Methods for Paging for Network Energy Saving

(71) Applicant: Continental Automotive Technologies GmbH, Hannover (DE)

(72) Inventors: Rikin Shah, Langen, Hessen (DE); Reuben George Stephen, Singapore (SG); David Gonzalez Gonzalez, Egelsbach, Hessen (DE); Andreas Andrae, Frankfurt am Main (DE)

(73) Assignee: Continental Automotive Technologies GmbH, Hannover (DE)

(21) Appl. No.: 19/153,677

(22) PCT Filed: Feb. 14, 2024
(86) PCT No.: PCT/EP2024/053667

§ 371 Date: Aug. 5, 2025

(30) Foreign Application Priority Data
Feb. 15, 2023 (DE) 102023201312.6

(51) Int. Cl. H04W 52/02; H04W 76/28

(52) U.S. Cl. CPC H04W 52/0206; H04W 76/28

(57) ABSTRACT

A method for Paging for Network Energy Saving in a wireless communication network, wherein a Small Base Station (BS) informs neighboring BS when it activates DTX.

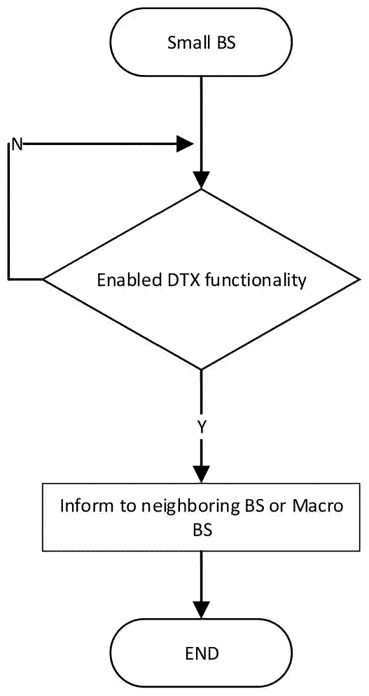

### CROSS REFERENCE TO RELATED APPLICATIONS

This application is the U.S. National Phase Application of PCT International Application No. PCT/EP2024/053667, filed Feb. 14, 2024, which claims priority to German Patent Application No. 102023201312.6, filed Feb. 15, 2023, the contents of such applications being incorporated by reference herein.

### TECHNICAL FIELD

The present disclosure relates to in wireless networks, and more particularly to methods and apparatus for Paging for Network Energy Saving.

### BACKGROUND

US 2021368378 A1, incorporated herein by reference, discloses a communication technique for combining, with an IoT technology, a 5G communication system for supporting a data transmission rate higher than that of a 4G system, and to a system therefor. The present disclosure may be applied to intelligent services (e.g., a smart home, a smart building, a smart city, a smart car or connected car, healthcare, digital education, retail business, security and safety-related service, etc.), based on a 5G communication technology and an IoT-related technology. A method for a user equipment in a first communication system according to an aspect of the present invention comprises steps in which a user equipment in an inactive state: transmits a paging area update request message; checks whether or not a timer associated with a paging area update has expired; and transitions into an idle state if a response message for the paging area update request message has not been received until the timer has expired.

US 2022110106 A1, incorporated herein by reference, discloses an apparatus comprising: comprising at least a first SIM associated with a first network and a second SIM associated with the first or a second network, wherein the first SIM is configured to operate in an idle or an inactive mode of a RRC while the second SIM configured to temporarily operate in a connected mode of the RRC and vice versa; means for allocating a radio transceiver of the apparatus for a communication of the first SIM and the second SIM for alternative active periods, wherein the first SIM is configured to at least monitor paging messages during its active periods and the second SIM is configured to at least perform beam management operations during its active periods; means for monitoring a number of scheduled beam management operations of the second SIM skipped during the active periods of the radio transceiver allocated for the first SIM; means for determining, based on at least data from the performed beam management operations, a threshold value for the skipped beam management operations; and means for adjusting, in response to the number of the skipped beam management operations reaching the threshold value, allocation of the active periods of the radio transceiver between the first SIM and the second SIM.

US 2018324751 A1, incorporated herein by reference, discloses a wireless device which may receive a compressed paging message broadcast from a base station, and transmit a connection request in response. The wireless device may include a paging response indication (e.g., indicating the connection request results from a received, false or genuine, paging request) and a wireless device identification (e.g., a UE ID) into the modified connection request. The base station may identify the connection request is in response to a paging broadcast by receiving the paging response indication, and determine if the connection request occurred in response to a false paging alert by comparing the received UE ID to the uncompressed paging request message list. If a match is found, the base station may transmit a connection establishment request. If a match is not found the base station may transmit a connection rejection message to the wireless device.

WO 2022011634 A1, incorporated herein by reference, discloses a method and a device for determining paging location or camping location. The method includes: determining information of a first location on which the UE camps or receives a paging message, wherein the information of the first location indicates a location of a bandwidth part (BWP) or a beam; and camping on or receiving the paging message on a corresponding BWP or beam according to the information of the first location.

US 2020322919 A1, incorporated herein by reference, discloses the apparatus of wireless communication may be a UE or a base station. The UE may determine a motion state of the UE that indicates a lack of motion, and transmit a request to the BS to perform a single beam paging based on determining that the motion state indicates the lack of motion. The UE may enter RRC inactive state or the RRC idle state and monitor for a page from the BS based on a single beam. The BS may receive the request to perform the single beam paging, and page the UE using the single beam. The UE in the RRC inactive state or the RRC idle state may transmit a request to perform the beam sweeping paging to the BS based on detecting a motion of the UE, and the BS may page the UE using multiple beams.

US 2021274466 A1, incorporated herein by reference, discloses new radio channel designs incorporate a synchronization signal burst series frame structure, with higher layer channels mapped to physical channels transmitted during a synchronization signal, allowing user equipment to select beams during which to listen for paging information. A physical common control channel configuration information element may be used to signal the paging configuration as part of the System Information. Paging may occur with or without user equipment assistance.

US 2019306829 A1, incorporated herein by reference, discloses a first RAN may determine beamforming information for a UE served by the first RAN. Then, the first RAN may transmit, to a second RAN or a core network, paging information for the UE served by the first RAN, wherein the paging information comprises the beamforming information for the UE. A core network component, e.g., an AMF, may receive the paging information comprising the beamforming information for the UE and may send a paging request to a second RAN for the transmission of a paging message to the UE, wherein the paging request is based on the received paging information. The second RAN may receive, from the first RAN or from the core network, paging information for the UE comprising beamforming assistance information for the UE. The second RAN may then transmit a paging message to the UE based on the beamforming assistance information.

US 2022046582 A1, incorporated herein by reference, discloses targeting paging reduction to improve upon power consumption performance for the user equipment in wireless networks. The methods and systems are disclosed where indication signal is applied for idle/inactive mode UEs. In one embodiment of the present disclosure, an indication signal is introduced for idle/inactive mode UEs for paging reception. In another embodiment, the group of UEs may be divided into plurality of paging sub-groups of UEs having common paging occasion and each paging sub-group be assigned a paging sub-group ID. This paging sub-group ID may be incorporated in the indicating signal to reduce paging reception. The indicating signal may indicate presence or absence of paging DCI for a UE/or a paging sub-group identity of UE/UEs.

Paging can be described as UE wakes up according to paging cycle, UE checks paging message in specific time (PO and PF), Identifying impact when cell has enabled energy saving functionality

To sum up the prior art describes gives no solution for how to enable good user experience in terms of data rate and latency when cell has enabled energy saving functionality.

### SUMMARY OF THE INVENTION

The cited problem is solved by a Small Base Station (BS) informing neighboring BS when it activates DTX Hereby X2 signaling is used. 1 bit is used to indicates such information. Also carries information regarding how long time it has enabled DTX Neighboring BS will enable DTX functionality accordingly. Co-located BS informs to Macro BS and Macro BS informs to other co-located BS

The benefit is that the user data rates and latency will be improved.

An aspect of the disclosure relates to a wireless communication system comprising a wireless network node and a wireless network node as describer hereinabove. According to an embodiment, steps of the methods described hereinabove are determined by computer program instructions.

Consequently, an embodiment of the present disclosure relates to a computer program stored on an information medium, said program being suitable to be implemented in user equipment device and/or a wireless network node, or more generally in a computer, said program comprising instructions configured to implement steps of the method for updating discontinuous reception by a wireless device and/or of the method for configuring discontinuous reception in a wireless device which has just been described.

The program can use any programming language, and be in the form of source code, object code, or of code intermediate between source code and object code, such as in a partially compiled form, or in any other desirable form.

A further aspect contemplates a computer-readable information medium comprising computer program instructions for implementing steps of the methods mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive. Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

A method for Paging for Network Energy Saving in a wireless communication network, wherein a Small Base Station (BS) informs neighboring BS when it activates DTX.

In some embodiments of the method according to the first aspect, the method is characterized by, that X2 signaling is used for informing the neighboring BS

In some embodiments of the method according to the first aspect, the method is characterized by, that 1 bit is used to indicates the signaling.

In some embodiments of the method according to the first aspect, the method is characterized by, that the activation carries information regarding how long time it has enabled DTX.

In some embodiments of the method according to the first aspect, the method is characterized by, that neighboring BS will enable DTX functionality accordingly.

In some embodiments of the method according to the first aspect, the method is characterized by, that co-located BS informs to Macro BS and Macro BS informs to other co-located BS.

According to a second aspect, the present disclosure relates to an apparatus for Paging for Network Energy saving in a wireless communication network to a wireless network node, apparatus comprising a processor coupled to a memory comprising computer program instructions stored thereon, processor being configured by instructions to perform the following the method according to the first aspect of this disclosure.

According to a third aspect, the present disclosure relates to a wireless network node comprising apparatus according to the second aspect comprising a processor coupled to a memory comprising computer program instructions stored thereon, said processor being configured by said instructions to perform the method according to the claims the first aspect of this disclosure.

According to a fourth aspect, the present disclosure relates to a wireless communication system comprising a wireless network node according to the third aspect of this disclosure.

According to a fifth aspect, the present disclosure relates to a computer program product comprising instructions for implementing a method according to the first aspect and/or instructions according the first aspect, when the program is executed by a processor.

According to a sixth aspect, the present disclosure relates to a non-transitory computer-readable storage medium comprising computer program instruction stored thereon for implementing a method for Paging for Network Energy Saving in a wireless communication network according the first aspect.

The advantages of the apparatus, user equipment, network node, wireless system, computer program and information medium are identical to those presented in relation with the corresponding methods according to any one of the embodiments mentioned hereinabove.

### BRIEF DESCRIPTION OF THE DRAWINGS

Other advantages and characteristics of aspects of the invention will be more clearly apparent on reading the following description, given by way of simple illustrative and nonlimiting example, and the appended drawings, among which:

The Figure illustrates a base station flow chart

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

Narrowband Internet of things (NB-IoT) is a low-power wide-area network (LPWAN) radio technology standard developed by 3GPP for cellular devices and services. The specification was frozen in 3GPP Release 13 (LTE Advanced Pro), in June 2016. Other 3GPP IoT technologies include eMTC (enhanced Machine-Type Communication) and EC-GSM-IoT. NB-IOT focuses specifically on indoor coverage, low cost, long battery life, and high connection density. NB-IoT uses a subset of the LTE standard, but limits the bandwidth to a single narrow-band of 200 kHz. It uses OFDM modulation for downlink communication and SC-FDMA for uplink communications. IoT applications which require more frequent communications will be better served by NB-IoT, which has no duty cycle limitations operating on the licensed spectrum.

The solution of the cited problem is Mobile aerial nodes provide reference location, flight path, and speed information,—“node type” indicator (vehicle, aerial, drone, etc.), node-specific beam pattern data (e.g., angular sector range, sector tilting, granularity).

For the sake of understanding in the figures some of the functional blocks are described textually.

The Figure shows the base station flow chart

In the following disclosure, reference will be made to user equipment and base station described above.

Small Base Station (BS) informs neighboring BS when it activates DTX, whreby X2 signaling is used. 1 bit is used to indicate the signaling as such information. It also carries information regarding how long time it has enabled DTX. Neighboring BS will enable DTX functionality accordingly. Co-located BS informs to Macro BS and Macro BS informs to other co-located BS.

Discontinuous reception (DRX) is a processing mode in a user equipment that aims at reducing power consumption. When using DRX, a user equipment periodically enters an active state (also referred as active time period, downlink monitoring period, or ON duration) to receive downlink data and signaling and then enters a sleep state (also referred as inactive state, inactive time period, or OFF duration) to stop monitoring on downlink data.

With the help of this disclosure an updating a discontinuous reception configuration is realized.

The DRX cycle is periodically repeated, leading to several ON durations noted A1,A2 and A3 separated by inactive time periods.

DRX is configured by the base station using RRC (Radio Resource Control) signaling, e.g. RRC ConnectionReconfiguration or RRC Connection Setup. Among other, DRX parameters may include:
drx-onDuration Timer: the time during which user equipment should stay active after it wakes up (referenced as “Active Time”). During this period, user equipment should monitor a physical downlink channel (e.g., PDCCH).
drx-inactivity Timer: this parameter corresponds to the delay during which the user equipment should remain in active state after being scheduled.
drx-SlotOffset defines the start of ON duration relative to the start of subframe boundary.

Once configured by the network, DRX cycles may be repeated until a new DRX configuration is received. Hence, user equipment may wake up even if there is no data to receive.

1. A method for Paging for Network Energy Saving in a wireless communication network, wherein a Small Base Station (BS) informs neighboring BS when it activates DTX.

2. The method according to claim 1 wherein X2 signaling is used for informing the neighboring BS

3. The method according to claim 1 wherein 1 bit is used to indicates the signaling.

4. The method according to claim 1 the activation carries information regarding how long time it has enabled DTX.

5. The method according to claim 1, wherein neighboring BS will enable DTX functionality accordingly.

6. The method according to claim 1, wherein co-located BS informs to Macro BS and Macro BS informs to other co-located BS.

7. An apparatus for Paging for Network Energy saving in a wireless communication network to a wireless network node, apparatus comprising a processor coupled to a memory comprising computer program instructions stored thereon, processor being configured by instructions to perform the following the method according to claim 1.

8. A wireless network node comprising apparatus according to claim 7 comprising a processor coupled to a memory comprising computer program instructions stored thereon, said processor being configured by said instructions to perform a method for Paging for Network Energy Saving in a wireless communication network, wherein a Small Base Station informs neighboring BS when it activates DTX.

9. A wireless communication system comprising a wireless network node according to claim 8.

10. A computer program product comprising instructions for implementing a method for updating a discontinuous reception configuration according to claim 1, when the program is executed by a processor.

11. A non-transitory computer-readable storage medium comprising computer program instruction stored thereon for implementing a method for Paging for Network Energy Saving in a wireless communication network according to claim 1.

12. A computer program product comprising instructions for implementing instructions according to claim 1 when the program is executed by a processor.

13. The method according to claim 2 wherein 1 bit is used to indicates the signaling.
